(19) United States
(12) Patent Application Publication
(10) Pub. No.: US 2024/0296349 A1
(43) Pub. Date: Sep. 5, 2024

(54) SYSTEMS AND METHODS FOR PREDICTIONS USING A KNOWLEDGE GRAPH

(71) Applicant: Verizon Patent and Licensing Inc., Basking Ridge, NJ (US)

(72) Inventors: Subham Biswas, Thane (IN); Keerthivasan Madurai, Chengalpattu (IN)

(21) Appl. No.: 18/176,891

(22) Filed: Mar. 1, 2023

(51) Int. Cl. G06N 5/022

(52) U.S. Cl. CPC G06N 5/022

(57) ABSTRACT

A device may include a processor configured to receive real-time data associated with a prediction usage system; determine one or more features associated with the received real-time data; select one or more relevant features, associated with a set of prediction output classes, based on the determined one or more features, using a knowledge graph for the set of prediction output classes; and provide the one or more relevant features as input to a prediction system for the set of prediction output classes. The processor may be further configured to obtain a prediction associated with the set of prediction output classes from the prediction system based on the provided one or more relevant features as input and provide the obtained prediction to the prediction usage system.

### BACKGROUND INFORMATION

To satisfy the needs and demands of users of mobile communication devices, providers of wireless communication services continue to improve and expand available services and networks used to deliver such services. Such improvements include the development of prediction systems. A prediction system may provide a prediction for parameters and/or services associated with a wireless communication system. A prediction system may process a large amount of information. Therefore, managing the resources associated with a prediction system may pose various difficulties.

### BRIEF DESCRIPTION OF THE DRAWINGS

FIG. 1 illustrates an environment according to an implementation described herein;

FIG. 2 illustrates exemplary components of a device that may be included in a component of an environment according to an implementation described herein;

FIG. 3 illustrates exemplary components of a prediction system according to an implementation described herein;

FIG. 4 illustrates exemplary components of a knowledge graph according to an implementation described herein;

FIG. 5 is a flowchart of a process for generating a knowledge graph according to an implementation described herein;

FIG. 6 is a flowchart of a process for using a knowledge graph for providing input to a prediction engine according to an implementation described herein;

FIG. 7 illustrates exemplary training data for generating a knowledge graph according to an implementation described herein;

FIG. 8 illustrates exemplary machine learning interpretability results used to generate a knowledge graph according to an implementation described herein;

FIG. 9 illustrates an exemplary representation of a knowledge graph according to an implementation described herein; and

FIG. 10 illustrates an exemplary process for generating a recommendation using a knowledge graph according to an implementation described herein.

### DETAILED DESCRIPTION OF EXAMPLE EMBODIMENTS

The following detailed description refers to the accompanying drawings. The same reference numbers in different drawings identify the same or similar elements.

A prediction engine may generate predictions for a set of prediction output classes. In the context of a wireless communication network and products and/or services managed by a provider of wireless communication services, a prediction engine may be used for various prediction uses, with a particular use associated with a set of prediction output classes. As an example, a prediction engine may generate a set of self-organizing network (SON) optimization parameters for a Radio Access Network (RAN) and/or a core network based on parameter values associated with the RAN and/or core network. As another example, a prediction engine may determine whether to deploy a particular microservice at a particular Multi-Access Edge Computing (MEC) site. As yet another example, a prediction engine may classify customer service tickets into service ticket classes and/or recommend a particular customer service agent for a particular service ticket. As yet another example, a prediction engine may classify maintenance, repair, and/or upgrade service tickets for devices in the RAN and/or core network and/or may recommend a particular maintenance, repair, and/or upgrade technician for a particular maintenance, repair, and/or upgrade ticket.

As yet another example, a recommendation engine may recommend products or services to a user based on different features associated with the user. For example, a recommendation engine may include a machine learning model trained to provide recommendations to users based on preferences, previous decisions, and/or characteristics associated with different users. A recommendation engine may use collaborative filtering based on user features, which include preference information for products and/or services associated with different types of users, such as users associated with a particular demographic category, a geographic location, etc. A recommendation engine may also use content filtering based on product/service features, which include the attributes of a product or service to identify similar products and/or services.

The number of different features that a prediction engine takes as an input may be quite large and require a lot of processing resources. For example, sending values for hundreds of different features to be used as input to determine a prediction may use a large amount of network bandwidth, fill up queues, and/or require significant processing power and/or time. Furthermore, a prediction engine may not be able to determine which input features carry more importance to generate an accurate prediction and may not be able to adequately differentiate between different types of prediction output classes. Additionally, a prediction engine may be difficult to update.

Implementations described herein relate to systems and methods for generating predictions using a time-based knowledge graph. A computer device may be configured to generate a knowledge graph for a set of prediction output classes based on training data that includes historical data associated with the prediction output classes. A “knowledge graph,” as used herein, may refer to a graph-structured data model that represents features as nodes and the relationships between the features as directional edges between the nodes, where an edge is assigned a value (herein referred to as a weight) that represents an importance of the relationship between the nodes. The generated knowledge graph may be used to select a set of features to be used as inputs to a prediction engine to generate a prediction for a prediction usage system.

The computer device may be further configured to use the generated knowledge graphs to select features to input to a prediction engine to generate a prediction for a prediction usage system. For example, the computer device may be configured to receive real-time data associated with a prediction usage system, determine features associated with the real-time data, and use a generated knowledge graph to select one or more relevant features associated with the set of prediction output classes using the knowledge graph. The computer device may be further configured to provide one or more relevant features as input to a prediction engine, obtain a prediction associated with the set of prediction output classes, and provide the obtained prediction to the prediction usage system.

The knowledge graph may be generated using historical data associated with the prediction usage system. The historical data may relate a set of features to a measure of success associated with the set of prediction output classes. The set of features may include time features, user features, device features, network parameter features, microservice/application features, product features, service ticket features, and/or other types of features that may be organized into a knowledge graph. The historical data may be used to generate a regression forecasting model that relates the set of features to the measure of success. The computer device may be configured to use a machine learning interpretability (MLI) model to rank input features associated with the regression forecasting model based on an importance to an output associated with the regression forecasting model, select a particular number of the highest ranked input features, and generate the knowledge graph using the selected particular number of input features.

For example, in an implementation that uses a recommendation engine for products and services, the training data may include time features, user features, and product/service features. The computer device may be configured to obtain training data that includes historical purchasing data associated with a set of products and/or services and generate a regression forecasting model using the obtained training data. The regression forecasting model may relate time features, product features, and user features to product/service values, such as the price at which a product or service was purchased by a user. The computer device may be configured to use an MLI model to rank input features associated with the regression forecasting model based on an importance to an output associated with the regression forecasting model, select a particular number of the highest ranked input features, and generate the knowledge graph using the selected particular number of input features.

The knowledge graph may relate time feature nodes, product/service feature nodes, and user feature nodes to user segment nodes. Furthermore, the MLI model may generate an importance score for a feature and the importance score may be assigned as a weight (also referred to as an edge weight) for edges from the node representing the feature. A user segment node may be associated with a user segment that identifies a particular user or a particular user type. A user type may be designated based on a demographic factor, a geographic location, a purchasing habit, and/or another type of characteristic that may be used to categorize users. Furthermore, a default knowledge graph, without user segment nodes, may be generated for users that are not classified in a particular user segment. The knowledge graphs may be updated at particular intervals with new training data by updating the regression forecasting model, the MLI model output from the regression forecasting model, and the knowledge graphs generated based on the MLI model output.

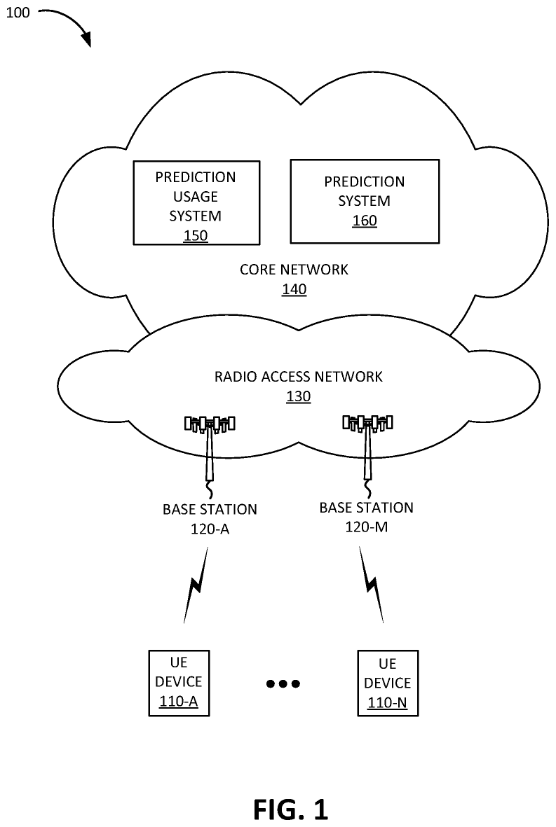

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), Radio Access Network (RAN) 130 that includes base stations 120-A to 120-M (referred to herein collectively as “base stations 120” and individually as “base station 120”), and core network 140 that includes a prediction usage system 150 and a prediction system 160.

UE device 110 may include any device with cellular wireless communication functionality. For example, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a laptop computer, a tablet computer, or another type of portable computer; a desktop computer; a customer premises equipment (CPE) device, such as a set-top box or a digital media player (e.g., Apple TV, Google Chromecast, Amazon Fire TV, etc.), a WiFi access point, a smart television, etc.; a portable gaming system; and/or any other type of computer device with wireless communication capabilities and a user interface. In some implementations, UE device 110 may communicate using machine-to-machine (M2M) communication, such as Machine Type Communication (MTC), and/or another type of M2M communication for Internet of Things (IoT) applications. UE device 110 may include capabilities for voice communication, mobile broadband services (e.g., video streaming, real-time gaming, premium Internet access etc.), best effort data traffic, and/or other types of applications.

RAN 130 may include base stations 120. Base station 120 may be configured for one or more Radio Access Technology (RAT) types. For example, base station 120 may include a 5G New Radio (NR) base station (e.g., a gNodeB) and/or a Fourth Generation (4G) Long Term Evolution (LTE) base station (e.g., an eNodeB). Base station 120 may include a radio frequency (RF) transceiver configured to communicate with UE devices 110 using a 5G NR air interface, a 4G LTE air interface, and/or using another type of cellular air interface.

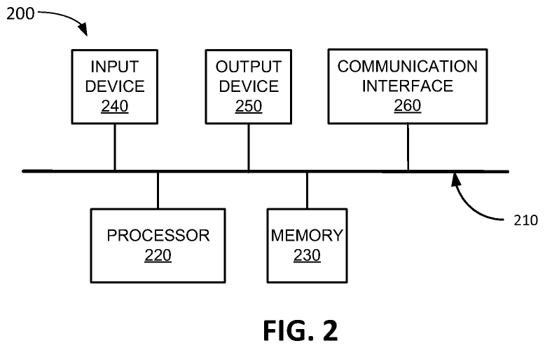

Core network 140 may be managed by a provider of cellular wireless communication services and may manage communication sessions of subscribers connecting to core network 140 via RAN 130. For example, core network 140 may establish an Internet Protocol (IP) connection between UE devices 110 and a packet data network (not shown in FIG. 1). The components of core network 140 may be implemented as dedicated hardware components or as virtualized functions implemented on top of a common shared physical infrastructure using software defined networking (SDN). For example, an SDN controller may implement one or more of the components of core network 140 using an adapter implementing a virtual network function (VNF) virtual machine, a Cloud Native Function (CNF) container, an event driven serverless architecture interface, and/or another type of SDN component. The common shared physical infrastructure may be implemented using one or more devices 200 described below with reference to FIG. 2 in a cloud computing center associated with core network 140. Additionally, or alternatively, some, or all, of the shared physical infrastructure may be implemented using one or more devices 200 implemented in a Multi-Access Edge Computing (MEC) network (not shown in FIG. 1) associated with RAN 130 and/or core network 140.

Prediction usage system 150 may include one or more computer devices, such as server devices, which uses predictions made by prediction system 160. Prediction usage system 150 may provide historical data to prediction system 160 that prediction system 160 may use to generate a knowledge graph. Furthermore, prediction usage system 150 may provide real-time data to prediction system 160 and request a prediction for the provided real-time data that prediction usage system 150 may then use.

As an example, prediction usage system 150 may include a SON system configured to adjust an optimization parameter associated with RAN 130 and/or core network 140. As another example, prediction usage system 150 may include a deployment system configured to deploy microservices in a MEC network (not shown in FIG. 1) associated with RAN 130 and/or core network 140. As yet another example, prediction usage system 150 may include a customer service system that processes customer tickets. As yet another example, prediction usage system 150 may include a network management system that processes maintenance, repair, and/or upgrade service tickets for devices in RAN 130 and/or core network 140.

As yet another example, prediction usage system 150 may include a catalog system that provides an online catalog for products and/or services. As an example, the catalog system may manage an online catalog of products for wireless communication services and/or wireless communication services available via a provider. As another example, the catalog system may manage a catalog of products and/or services associated with the online shopping application. As yet another example, the catalog system may manage an online catalog of video and/or audio assets for streaming and/or downloading. In some implementations, the catalog system may be associated with and/or managed by a provider of communication services that manages RAN 130 and/or core network 140. Prediction usage system 150 may obtain a recommendation to provide to a user from prediction system 160 and may present the obtained recommendation to the user. As an example, a user may be accessing a web page associated with a product, a service, a category of products or services, etc., and may be provided with one or more recommendations. As another example, a user may add an item to an online shopping cart and be presented with, in response, a recommendation for additional items. As yet another example, prediction usage system 150 may send messages to users at particular intervals to provide registered users with recommendations.

Prediction system 160 may include one or more computer devices, such as server devices, which provides predictions for prediction usage system 150. Prediction system 160 may include a prediction engine that takes as input a set of features received from prediction usage system 150 and may output a prediction based on the set of features. Furthermore, prediction system 160 may generate a knowledge graph and use the knowledge graph to select a subset of features from the set of features as relevant features to input into the prediction engine.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 illustrates example components of a device 200 according to an implementation described herein. UE device 110, base station 120, prediction usage system 150, and/or prediction system 160 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., RF, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to one or more antennas/antenna arrays for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™M wireless interface, a radio-frequency identification (RFID) interface, a near-field communications (NFC) wireless interface, and/or any other type of interface that converts data from one form to another form.

As will be described in detail below, in an implementation, device 200 may perform certain operations relating to generating a knowledge graph for input features for a prediction system and using the knowledge graph to select features to input into a prediction system to generate a prediction. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

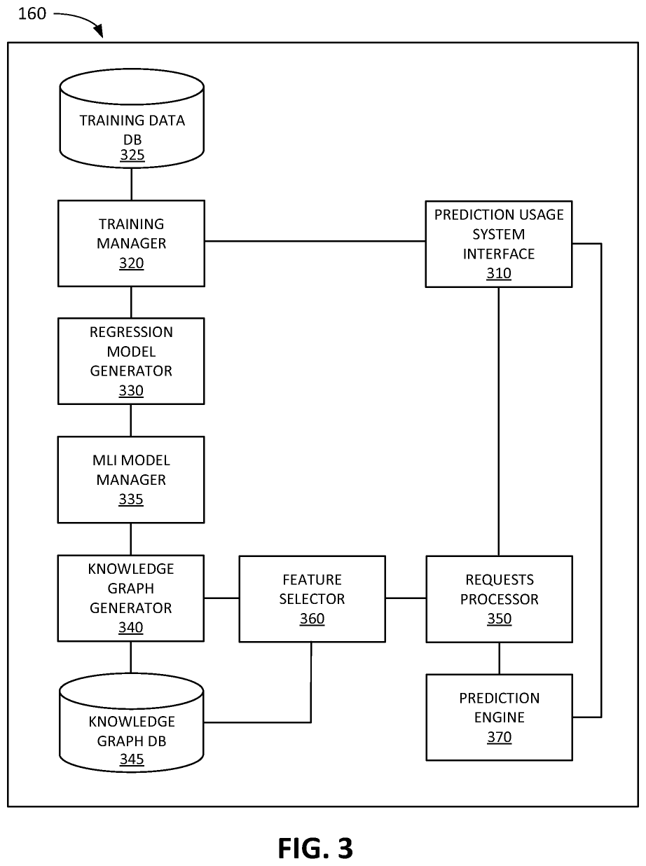

FIG. 3 is a diagram illustrating exemplary components of prediction system 160. The components of prediction system 160 may be implemented, for example, via processor 220 executing instructions from memory 230. Alternatively, some or all of the components of prediction system 160 may be implemented via hard-wired circuitry. As shown in FIG. 3, prediction system 160 may include a prediction usage system interface 310, a training manager 320, a training data database (DB) 325, a regression model generator 330, an MLI model manager 335, a knowledge graph generator 340, a knowledge graph DB 345, a requests processor 350, a feature selector 360, and a prediction engine 370.

Prediction usage system interface 310 may be configured to interface with prediction usage system 150. For example, prediction usage system interface 310 may collect training data from prediction usage system 150 and provide the obtained training data to training manager 320. Furthermore, prediction usage system interface 310 may process requests for predictions from prediction usage system 150. For example, prediction usage system interface 310 may receive a real-time request, for a prediction, that includes a set of features, and provide the real-time request to requests processor 350. Prediction usage system interface 310 may then receive a prediction based on the real-time request from prediction engine 370 and provide the prediction to prediction usage system 150.

Training manager 320 may manage training data used to generate a regression forecasting model for features used to generate a prediction. Training manager 320 may receive, process, and store training data in training data DB 325 and may provide the training data to regression model generator 330 to generate a regression forecasting model based on the training data. For example, training manager 320 may generate input vectors with a particular set of features based on the training data and provide the generated input vectors to regression model generator 330.

Furthermore, in implementations that use training data that includes user features, the training data may be organized into training data associated with known or registered users and training data associated with new or unknown users. For example, training data for a catalog system that includes known or registered users may include user features, such as a profile of a user's purchasing habits (e.g., “cost-saver,” “tech savvy,” “big spender,” “browser,” etc.), a geographic location associated with the user, one or more demographic factors associated with the user (e.g., age, gender, nationality, income level, education level, etc.), a group associated with the user (e.g., a business enterprise, a government agency, an organization, etc.), the user's preferred or favorite brand, and/or other types of user features. Training data associated with new or unknown users may not include user features, or may include a reduced set of user features (e.g., geographic location only).

Regression model generator 330 may generate a regression forecasting model using training data received from training manager 320. For example, the training data for a catalog system may include a set of time features, a set of product/service features, and a set of user features associated with a purchase of an item or service made by a user via prediction usage system 150. Furthermore, the training data may include a purchase amount associated with the purchase of the item or service. Regression model generator 330 may train a regression model to predict a purchase value based on a set of input features. Regression model generator 330 may generate a first regression forecasting model for known or registered users using training data associated with known or registered users and a second regression forecasting model for new or unknown users using training data associated with new or unknown users.

In other implementations, different measures of success may be used to train the regression model. As an example, in an implementation that predicts optimization parameters for a SON system, the training data may include input vectors that each define a network state and a set of optimization parameter adjustments and that are associated with a measure of success based on changes in one or more performance parameters. As another example, in an implementation that predicts deployment of microservices in a MEC network, the training data may include input vectors that define a set of microservice requirements and microservice deployments and that are associated with a measure of success based on improvements in latency associated with the microservices. As yet another example, in an implementation that classifies customer service, the training data may include input vectors that define a set of user features, a set of time features, and a set of service ticket features and are associated with a measure of success based on ticket resolution time. As yet another example, in an implementation that classifies maintenance, repair, and/or upgrade service tickets, the training data may include input vectors that define a set of device or network service features, a set of time features, and a set of service ticket features and are associated with a measure of success based on ticket resolution time.

MLI model manager 335 may perform MLI on the trained regression model using an MLI model. Examples of MLI models used by MLI model manager 335 may include a Local Interpretable Model-Agnostics Explanations (LIME) model, a Shapley Additive Explanations (SHAP) model, a Building Blocks of Interpretability (BBI) model, and/or another type of MLI model. The MLI model may determine the contribution made by each input feature to the predicted purchase value (e.g., by eliminating an input feature and determining how the output changes, etc.) and may rank the input features based on the importance of each input feature to the output value. The MLI output may include a ranked list of features along with an importance score for each feature, indicating the importance of the feature to the output.

In implementations that use training data that includes user features, MLI model manager 335 may generate a first set of MLI results for known or registered users using the regression forecasting model for known or registered users and a second set of MLI results for new or unknown users using the regression forecasting model for new or unknown users.

In some implementations, the training data may include data associated with user activity that did not result in a purchase. For example, a user may have browsed web pages hosted by prediction usage system 150 and not made a purchase. Prediction usage system 150 may provide training data associated with user events that did not result in a purchase and regression model generator 330 may generate a “non-purchase” regression model, based on the data, where the purchase value corresponds to zero. MLI model manager 335 may then perform MLI analysis to generate a ranked list of features based on the contribution of the features to the resulting lack of a purchase. The top X features identified by the MLI analysis may then be designated as features to avoid and be excluded from being included in the set of relevant features provided to prediction engine 370.

Knowledge graph generator 340 may generate a knowledge graph based on the MLI output. For example, knowledge graph generator 340 may select the top N (e.g., top ten, top five, top fifteen, etc.) features from the MLI results. In implementations that use training data that includes user features, knowledge graph generator 340 may generate a first knowledge graph for known or registered users using the MLI results for the known or registered users and a second knowledge graph for new or unknown users using the MLI results for new or unknown users.

For a knowledge graph associated with known or registered users, knowledge graph generator 340 may first generate a set of user segment nodes. Each user segment node may represent a user segment defined by a set of user features. For example, a first user segment may be associated with a first geographic location, a first brand preference, and a first purchasing habits profile; and a second user segment may be associated with a second geographic location, a second brand preference, and a second purchasing habits profile. Knowledge graph generator 340 may then generate a feature node for each selected feature from the MLI results that is associated with the user segment and may generate an edge from each of the feature nodes to the user segment nodes. Furthermore, knowledge graph generator 340 may assign a weight to an edge based on an importance score of the feature, associated with the feature node from which the edge originates, generated by the MLI results. Thus, elements of the knowledge graph may be stored in a (node 1, edge weight, node 2) format, wherein the edge weight corresponds to the importance score associated with node 1.

Additional edges may be added to the knowledge graph based on dependencies associated with particular features. As an example, a user's preferred brand may be associated with the user's shopping habits profile, indicating a dependency between a preferred brand feature and a shopping habits profile feature. As another example, a time at which users in different geographic locations tend to make purchases may be different, indicating a dependency between a time feature and a location feature. As yet another example, products associated with a particular brand may be associated with a higher quality rating than products associated with another brand, indicating a dependency between a brand feature and a quality rating feature. Knowledge graph generator 340 may identify dependencies between features based on the training data and may add an edge from a first feature to a second feature if the second feature depends on the first feature. Additionally, or alternatively, edges based on dependencies may be manually added to a knowledge graph by a domain knowledge expert.

For a knowledge graph associated with unknown, new, or non-registered users, knowledge graph generator 340 may generate a default knowledge graph. Knowledge graph generator 340 may generate a default user node and then generate a feature node for each selected feature from the MLI results and may generate an edge from each of the feature nodes to the default user node. Since unknown, new, or non-registered users may be associated with no user features, or a reduced user feature list, the default knowledge graph may include no user feature nodes or a reduced set of user feature nodes. Furthermore, the importance score may be used to build a hierarchy in the default knowledge graph based on the rank of each selected feature in the MLI results.

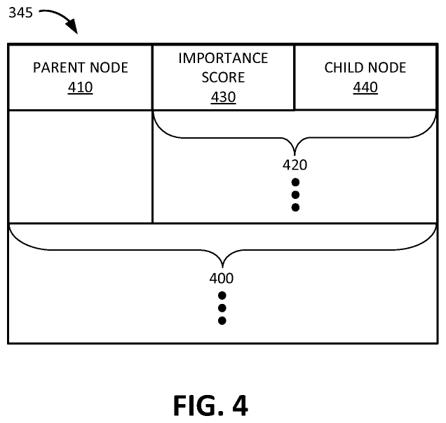

The knowledge graphs may be updated at particular intervals based on new training data. The new training data may be used to update the regression forecasting model, which may then be used to update the MLI results, which may then be used to update the knowledge graphs. Knowledge graph DB 345 may store knowledge graphs generated by knowledge graph generator 340. Exemplary information that may be stored in knowledge graph DB 345 is described below with reference to FIG. 4.

Requests processor 350 may process requests for recommendations received from prediction usage system 150. For example, requests processor 350 may receive a request for a recommendation from prediction usage system interface 310. The request may include one or more time features associated with the request and/or one or more other types of features, such as user features associated with the request. Requests processor 350 may provide the features associated with the request to feature selector 360.

Feature selector 360 may select a set of relevant features based on the features associated with the request using information stored in knowledge graph DB 345. For example, feature selector 360 may select a knowledge graph based on the user features included in the request. If the request does not include user features (or is missing particular user features), feature selector 360 may search a default knowledge graph. For example, feature selector 360 may match features in the default knowledge graph with the features in the request (e.g., by performing a string matching search, etc.) and may select as relevant features the top N matching features from the default knowledge graph based on the hierarchy of the features in the default knowledge graph.

If the request does include particular user features, feature selector 360 may search a knowledge graph that includes user segments. For example, feature selector 360 may identify a user segment based on user features included in the request. Feature selector 360 may then match features in the user segments knowledge graph with features in the request and may select the top N matching features with edges to the identified user segment based on the importance scores associated with the edges. Feature selector 360 may provide the selected set of relevant features to prediction engine 370.

Prediction engine 370 may include a machine learning model trained to generate a set of recommendations for products and/or services available for purchase via prediction usage system 150. The machine learning model may generate the recommendations based on a set of input features. The set of input features may be large (e.g., over 100 input features, etc.) and many of the input features may provide an insignificant contribution to the output of a recommendation. Prediction engine 370 may generate a faster and/or more efficient recommendation when a smaller set of input features is provided. Prediction engine 370 may include, for example, a deep learning neural network, another type of neural network, and/or another type of machine learning model, such as, for example, a Support Vector Machine (SVM) classifier, a K-nearest neighbors (KNN) classifier, a naïve Bayesian classifier, a random forest classifier, a logistic regression classifier, a linear discriminant analysis classifier, a quadratic linear discriminant analysis classifier, a maximum entropy classifier, a kernel density estimation classifier, a principal component analysis (PCA) classifier, etc.

Although FIG. 3 shows exemplary components of prediction system 160, in other implementations, prediction system 160 may include fewer components, different components, additional components, or differently arranged components than depicted in FIG. 3. Additionally, or alternatively, one or more components of prediction system 160 may perform one or more tasks described as being performed by one or more other components of prediction system 160.

FIG. 4 illustrates exemplary components of knowledge graph DB 345. As shown in FIG. 4, knowledge graph DB 345 may include one or more knowledge graph records 400. Each knowledge graph record 400 may store information relating to a particular knowledge graph. Knowledge graph record 400 may include one or more parent nodes 410. Each parent node 410 may store information relating to a feature node. Parent node 410 may include a name of the feature associated with the feature node. Each parent node 410 may be associated with one or more edges 420. Each edge 420 may include an importance score 430 and a child node 440. Importance score 430 may store an importance score associated with edge 420. Child node 440 may identify another parent node 410 in knowledge graph 400.

Although FIG. 4 shows exemplary components of knowledge graph DB 345, in other implementations, knowledge graph DB 345 may include fewer components, different components, additional components, or differently arranged components than depicted in FIG. 4.

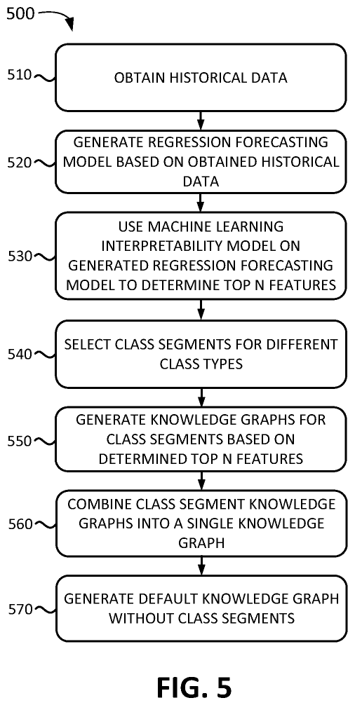

FIG. 5 is a flowchart of a process 500 for generating a knowledge graph. In some implementations, process 500 of FIG. 5 may be performed by prediction system 160. In other implementations, some or all of process 500 may be performed by another device or a group of devices.

As shown in FIG. 5, process 500 may include obtaining historical data (block 510). For example, prediction system 160 may obtain training data from a catalog system implemented in prediction usage system 150 based on purchase events and/or non-purchase events associated with user activity browsing an online catalog hosted by prediction usage system 150.

Prediction system 160 may organize the training data into feature vectors that include time features, user features, and product/service features, and that include a training label corresponding to the purchase price of a purchased item associated with a purchase event (or a purchase price of zero for non-purchase events). Furthermore, the training data may be organized into training data associated with known or registered users and training data associated with new or unknown users.

As another example, prediction system 160 may obtain, from a SON system implemented in prediction usage system 150, input vectors that define a set of optimization parameter adjustments associated with a measure of success based on changes in one or more performance parameters. As yet another example, prediction system 160 may obtain, from a MEC deployment system implemented in prediction usage system 150, input vectors that define a set of microservice deployments associated with a measure of success based on improvements in latency associated with the microservices. As yet another example, prediction system 160 may obtain, from a customer service ticket system implemented in prediction usage system 150, input vectors that define a set of user features, a set of time features, and a set of service ticket features and are associated with a measure of success based on ticket resolution time. As yet another example, prediction system 160 may obtain, from a network management system implemented in prediction usage system 150, input vectors that define a set of device or network service features, a set of time features, and a set of service ticket features and are associated with a measure of success based on ticket resolution time.

Process 500 may further include generating a regression forecasting model based on the obtained historical purchase data (block 520). For example, prediction system 160 may train a regression model to predict a purchase value based on a set of input features. Prediction system 160 may generate a first regression forecasting model for known or registered users using training data associated with known or registered users and a second regression forecasting model for new or unknown users using training data associated with new or unknown users. As another example, prediction system 160 may use a different measure of success to generate a regression forecasting model based on the particular implementation of prediction usage system 150, such as, for example, changes in one or more performance parameters for a SON system, improvements in latency associated with the microservices for a MEC deployment system, ticket resolution time for a customer service ticket system or a network management system, etc.

Process 500 may further include using an MLI model on the generated regression forecasting model to determine the top N features (block 530). For example, prediction system 160 may perform MLI analysis on the generated forecasting model to obtain a set of MLI results that include a ranked list of features along with an importance score, for each feature, indicating the importance of the feature to the output. Prediction system 160 may generate a first set of MLI results for known or registered users using the regression forecasting model for known or registered users and a second set of MLI results for new or unknown users using the regression forecasting model for new or unknown users. Furthermore, prediction system 160 may perform MLI analysis to generate a ranked list of non-relevant features based on the contribution of the features to the resulting lack of a purchase, based on non-purchase training data. The non-relevant features may then be designated as features to avoid and be excluded from being included in the set of relevant features provided to prediction engine 370.

Process 500 may further include selecting class segments for different class types (block 540), generating knowledge graphs for class segments based on the determined top N features (block 550), and combining the class segment knowledge graphs into a single knowledge graph (block 560). For example, prediction system 160 may use user segments as class segments for different user types and first generate a set of user segment node with each user segment node defined by a set of user features. Prediction system 160 may then generate a feature node for each selected feature, from the MLI results, that is associated with the user segment and may generate an edge from each of the feature nodes to the user segment nodes with a weight based on an importance score for the feature generated by the MLI results. In other implementations, different class segments may be used. For example, prediction system 160 may use device or network service types as class types for a SON system, microservice types as class types for a MEC deployment system, service ticket types for a customer service ticket system or a network management system, etc.

Process 500 may further include generating a default knowledge graph without class segments (block 570). For example, prediction system 160 may generate a default user node (or another type of default class node) and then generate a feature node for each selected feature from the MLI results and may generate an edge from each of the feature nodes to the default user node. The default knowledge graph may include no user feature nodes or a reduced set of user feature nodes.

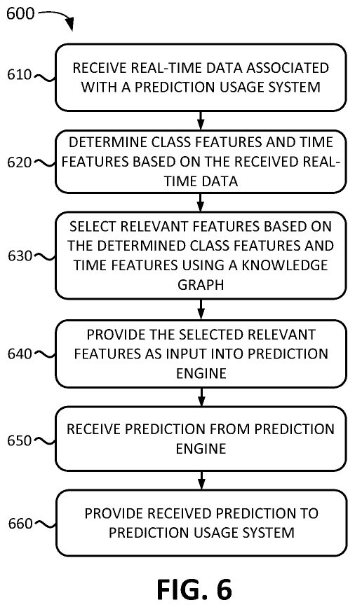

FIG. 6 is a flowchart of a process 600 for using a knowledge graph for providing input to a prediction engine. In some implementations, process 600 of FIG. 6 may be performed by prediction system 160. In other implementations, some or all of process 600 may be performed by another device or a group of devices.

As shown in FIG. 6, process 600 may include receiving real-time data associated with a user (block 610) and determining class features and time features based on the received real-time data (block 620). For example, prediction system 160 may receive a real-time request from prediction usage system 150 for a recommendation associated with a user event. The request may include a set of time features (e.g., a time, a day, a month, etc.) associated with the real-time request and/or a set of user features (e.g., information identifying a particular user, information identifying a particular user segment, one or more features that may be used to identify a user segment, etc.) associated with the real-time request.

As another example, prediction system 160 may obtain, from a SON system implemented in prediction usage system 150, a network state and a set of current optimization parameters. As another example, prediction system 160 may obtain, from a MEC deployment system implemented in prediction usage system 150, a set of microservice requirements and deployments. As another example, prediction system 160 may obtain, from a customer service ticket system implemented in prediction usage system 150, a request to classify a customer service ticket. As yet another example, prediction system 160 may obtain, from a network management system implemented in prediction usage system 150, a request to classify a maintenance, repair, or upgrade service ticket for a device or network service in RAN 130 and/or core network 140.

Process 600 may further include selecting relevant features based on the determined class features and time features using a knowledge graph for products and/or services (block 630). For example, prediction system 160 may select a knowledge graph and search the knowledge graph to identify a set of relevant features based on the determined features associated with the received request. Prediction system 160 may select a set of top N relevant features based on the hierarchical organization of the knowledge graph and/or based on importance scores associated with edges originating from the features of the knowledge graph that match features in the received request.

Process 600 may further include providing the selected relevant features as input to a prediction engine (block 640), receiving a recommendation from the prediction engine (block 650), and providing the received recommendation to the user (block 660). For example, prediction system 160 may input the selected set of relevant features to prediction engine 370 and prediction engine 370 may output one or more recommendations for products and/or services associated with prediction usage system 150. Prediction system 160 may provide the recommendations to prediction usage system 150 and prediction usage system 150 may present the recommendations to the user.

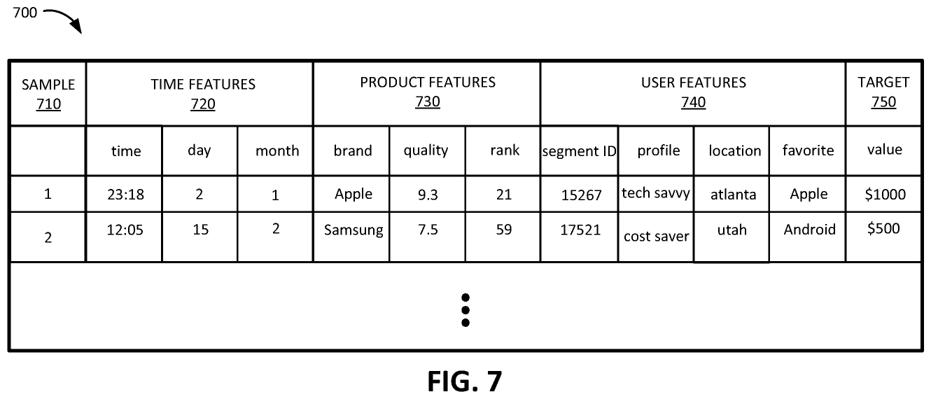

FIG. 7 illustrates exemplary training data 700 for generating a knowledge graph for a recommendation system for an online catalog of products and/or services. As shown in FIG. 7, training data 700 may include a set of training vectors, with each training vector including a set of features. Each training vector may represent a purchase made by a user. A training vector may include a sample identifier (ID) value 710, a set of time features 720, a set of product features 730, a set of user features 740, and a target label 750.

Sample ID value 710 may include an ID that uniquely identifies a training vector for a purchase made by a user. Time feature values 720 may include one or more time features associated with the purchase made by the user. For example, time features 720 may include a value for a time feature, a value for a day of the week feature, and a value for a month feature corresponding to the time, day and month of the purchase made by the user. Product features 730 may include one or more product features associated with the purchase made by the user. For example, product features 730 may include a value for a brand identifying feature, a value for a quality score feature, and a value for a rank feature associated with the purchase made by the user. The brand identifying feature may identify the brand associated with the purchased item.

The quality score feature may identify a quality score assigned to the purchased item. The rank feature may identify a rank assigned to the purchased item compared to other items in a catalog of products.

User features 740 may include one or more user features associated with the user that made the purchase. For example, user features 740 may include a segment ID value, a value for a purchasing profile feature, a value for a location feature, and a value for a favorite brand feature. The segment ID value may identify a user segment associated with the user. The segment ID value may not be used as an input feature and may be included in the training vector for identification purposes. The purchasing profile feature may identify a purchasing habit associated with the user, such as whether the user is a tech savvy shopper, a cost saver shopper, a shopper that likes to make large purchases, a shopper that browses without purchasing, etc. The location feature may identify a geographic location associated with the user. The favorite brand feature may identify a favorite brand for the user.

Target label 750 may include a value corresponding to the purchase amount associated with the item purchased by the user. Target label 750 may correspond to the target label for the training data vector and may be used as the target to training the regression forecasting model with the training data vector. While FIG. 7 illustrates particular features that may be included in training data 700, in other implementations, training data 700 may include fewer features, different features, additional features, or differently arranged features than depicted in FIG. 7. Prediction system 160 may use training data 700 to generate a regression forecasting model that forecasts a purchase value based on the features included in training data 700.

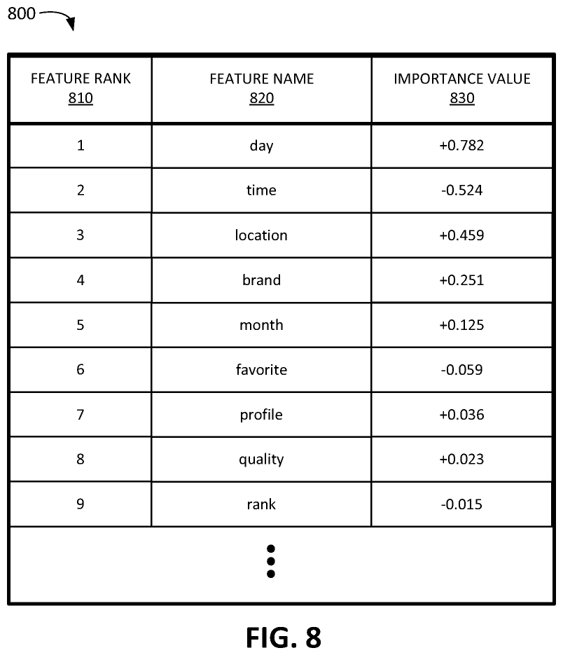

FIG. 8 illustrates exemplary MLI results 800 used to generate a knowledge graph according to an implementation described herein. Prediction system 160 may use an MLI model to generate MLI results 800 based on a regression forecasting model generated using training data 700. As shown in FIG. 8, MLI results 800 may include a feature rank column 810, a feature name column 820, and an importance value column 830.

Feature number column 810 may include a feature rank for each feature identified by the MLI model. The features may be ranked from the most important feature to the least important feature, with the importance corresponding to how much a particular feature contributes to the output forecast by the regression model. Feature name column 820 may include a name for each feature identified by the MLI model. Importance value column 830 may store an importance score value identified for the feature by the MLI model. The magnitude of the importance score value represents the relative contribution of the feature to the prediction value output by the regression forecasting model. A positive importance score value indicates that the feature contributed towards increasing the prediction value and a negative importance score value indicates that the feature contributed towards decreasing the prediction value.

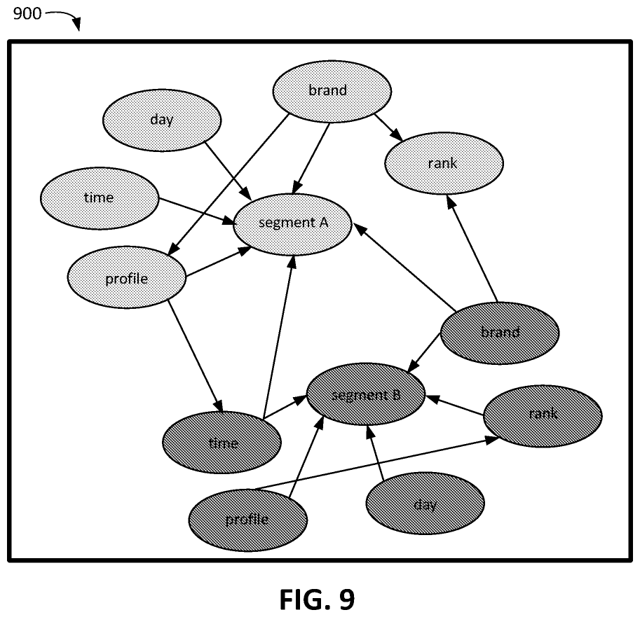

FIG. 9 illustrates an exemplary graphical representation of knowledge graph 900 according to an implementation described herein. As shown in FIG. 9, knowledge graph 900 includes combined knowledge graphs generated for two different user segments: segment A and segment B. Each user segment may be defined by a set of user features. Additionally, or alternatively, a user segment may be associated with an individual user. Each user segment may have a set of feature nodes with edges that extend to a node representing the user segment. The feature nodes may represent a set of top N (e.g., top five, top ten, etc.) features from the ranked list of features from MLI results 800.

For example, knowledge graph 900 includes a day feature node, a time feature node, a user profile feature node representing a user's profile based on purchasing habits, a brand feature node, and a rank feature node with edges to the segment A node. Furthermore, knowledge graph 900 includes a time feature node, a day feature node, a user profile feature node, a brand feature node, and a rank feature node with edges to the segment B node. Each edge may be associated with an importance score corresponding to the importance score of the feature from which the edge originates.

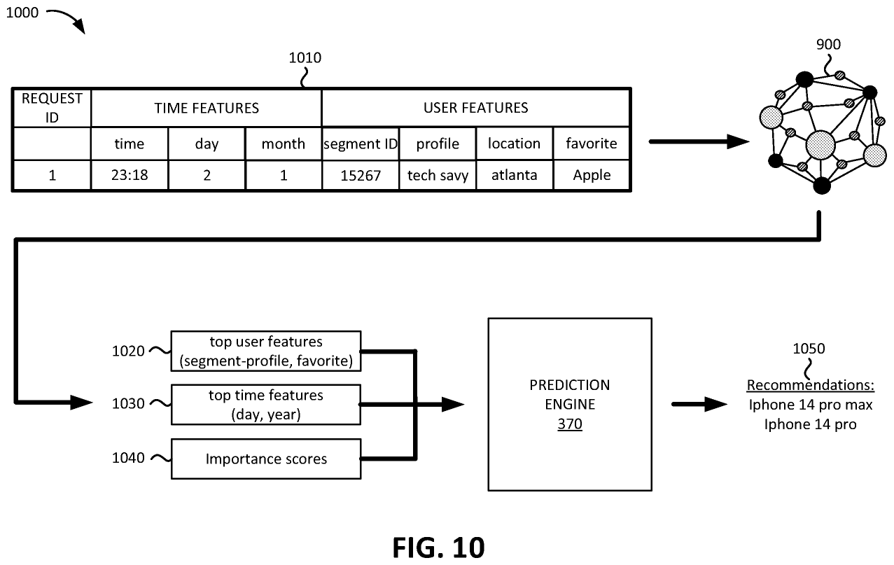

FIG. 10 illustrates an exemplary process 1000 for generating a recommendation using a knowledge graph according to an implementation described herein. As shown in FIG. 10, process 1000 includes obtaining real-time data 1010 for a user. Real-time data 1010 may be obtained, for example, based on a user browsing web pages hosted by a catalog system implemented in prediction usage system 150, based on a user requesting a recommendation, etc.

Real-time data 1010 may be used to generate a feature vector with time features and user features. The feature vector may be used to search knowledge graph 900 to determine a set of relevant features associated with the real-time data. For example, prediction system 160 may identify the user segment associated with real-time data 1010. Prediction system 160 may then select relevant features from knowledge graph 900 with edges to the identified user segment, and which have an importance score higher than a threshold. The selected relevant feature may include user features 1020 and time features 1030. Additionally, in some implementations, prediction system 160 may also retrieve the importance scores 1040 associated with the selected relevant features.

The selected relevant user features 1020, time features 1030, and importance scores 1040 may be provided as input to prediction engine 370. Prediction engine 370 may output one or more product recommendations 1050 and prediction system 160 may provide product recommendations 1050 to prediction usage system 150. Prediction usage system 150 may present product recommendations 1050 to the user by, for example, displaying product recommendations 1050 in a web page, sidebar, pop-up window, etc. Additionally, or alternatively, prediction usage system 150 may send product recommendations 1050 to the user in a message (e.g., email message, text message, chat message, etc.).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 5 and 6, the order of the blocks may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a device, real-time data associated with a prediction usage system;
determining, by the device, one or more features associated with the received real-time data;
selecting, by the device, one or more relevant features, associated with a plurality of prediction output classes, based on the determined one or more features, using a knowledge graph for the plurality of prediction output classes;
providing, by the device, the one or more relevant features as input to a prediction system for the plurality of prediction output classes;
obtaining, by the device, a prediction associated with the plurality of prediction output classes from the prediction system based on the provided one or more relevant features as input; and
providing, by the device, the obtained prediction to the prediction usage system.

2. The method of claim 1, wherein the prediction output classes include a plurality of products, the method further comprising:
generating the knowledge graph for the plurality of products based on a plurality of product features, a plurality of user features, and a plurality of time features.

3. The method of claim 2, wherein generating the knowledge graph includes:
obtaining training data that includes historical purchasing data associated with the plurality of products.

4. The method of claim 3, further comprising:
generating a regression forecasting model using the obtained training data, wherein the regression forecasting model relates the plurality of product features, the plurality of user features, and the plurality of time features to product values associated with the plurality of products.

5. The method of claim 4, further comprising:
using a machine learning interpretability (MLI) model to rank input features associated with the regression forecasting model based on an importance of an output associated with the regression forecasting model;
selecting a particular number of highest ranked input features; and
generating the knowledge graph using the selected particular number of highest ranked input features.

6. The method of claim 5, wherein the knowledge graph relates the input features to user features, and wherein an edge weight for an edge associated with an input feature is based on an importance score, for the input feature, determined by the MLI model.

7. The method of claim 1, wherein the knowledge graph relates one or more user features, one or more time features, and one or more product features to user segment nodes, wherein a particular user segment node identifies a user type.

8. The method of claim 7, wherein the user type is defined by one or more of a purchasing habit, a geographic location, or at least one demographic factor.

9. The method of claim 7, wherein the knowledge graph includes a default knowledge graph that does not include user segment nodes.

10. The method of claim 1, further comprising:
updating the knowledge graph at particular intervals.

11. A device comprising:
a processor configured to:
receive real-time data associated with a prediction usage system;
determine one or more features associated with the received real-time data;
select one or more relevant features, associated with a plurality of prediction output classes, based on the determined one or more features, using a knowledge graph for the plurality of prediction output classes;
provide the one or more relevant features as input to a prediction system for the plurality of prediction output classes;
obtain a prediction associated with the plurality of prediction output classes from the prediction system based on the provided one or more relevant features as input; and
provide the obtained prediction to the prediction usage system.

12. The device of claim 11, wherein the prediction output classes include a plurality of products, and wherein the processor is further configured to:
generate the knowledge graph for the plurality of products based on a plurality of product features, a plurality of user features, and a plurality of time features.

13. The device of claim 12, wherein, when generating the knowledge graph, the processor is further configured to:
obtain training data that includes historical purchasing data associated with the plurality of products.

14. The device of claim 13, wherein the processor is further configured to:
generate a regression forecasting model using the obtained training data, wherein the regression forecasting model relates the plurality of product features, the plurality of user features, and the plurality of time features to product values associated with the plurality of products.

15. The device of claim 14, wherein the processor is further configured to:
use a machine learning interpretability (MLI) model to rank input features associated with the regression forecasting model based on an importance of an output associated with the regression forecasting model;
select a particular number of highest ranked input features; and
generate the knowledge graph using the selected particular number of the highest ranked input features.

16. The device of claim 15, wherein the knowledge graph relates the input features to user features, and wherein an edge weight for an edge associated with an input feature is based on an importance score, for the input feature, determined by the MLI model.

17. The device of claim 11, wherein the knowledge graph relates one or more user features, one or more time features, and one or more product features to user segment nodes, wherein a particular user segment node identifies a user type, and wherein the user type is defined by one or more of a purchasing habit, a geographic location, or at least one demographic factor.

18. The device of claim 17, wherein the knowledge graph includes a default knowledge graph that does not include user segment nodes.

19. The device of claim 11, wherein the processor is further configured to:
update the knowledge graphs at particular intervals.

20. A non-transitory computer-readable memory device storing instructions executable by a processor, the non-transitory computer-readable memory device comprising:
one or more instructions to receive real-time data associated with a prediction usage system;
one or more instructions to determine one or more features associated with the received real-time data;
one or more instructions to select one or more relevant features, associated with a plurality of prediction output classes, based on the determined one or more features, using a knowledge graph for the plurality of prediction output classes;
one or more instructions to provide the one or more relevant features as input to a prediction system for the plurality of prediction output classes;
one or more instructions to obtain a prediction associated with the plurality of prediction output classes from the prediction system based on the provided one or more relevant features as input; and
one or more instructions to provide the obtained prediction to the prediction usage system.
